(19) United States
(12) Patent Application Publication
(10) Pub. No.: US 2005/0238950 A1
(43) Pub. Date: Oct. 27, 2005

(54) Loubelle cell pack

(76) Inventor: Lou Smith, Fayetteville, NC (US)

Correspondence Address: LOU SMITH, 336 WEST WATER, FAYETTEVILLE, NC, 28301, US

(21) Appl. No.: 10/831,556

(22) Filed: Apr. 26, 2004

(51) Int. Cl. H01M 2/10; H01M 6/00

(52) U.S. Cl. 429/122; 429/96

(57) ABSTRACT

A method of providing a portable, light weight, longer lasting, rechargeable primary or supplemental electric power source for cellular telephones, portable compact disc players, personal digital video disc players, televisions, laptop computers and similar devices is an object of the present invention.

### FIELD OF THE INVENTION

In general, the field of the present invention relates to extending the use and enjoyment of personal electronic devices by increasing the amount of time such devices can be utilized without requiring recharging.

### BACKGROUND OF THE INVENTION

There are many personal electronic devices that the users carry on their persons, including but not limited to cellular telephones, portable compact disc players, mp3 players, portable digital video disc players, portable search lights and the like. All of these devices use batteries as their primary power source and have adaptors that allow them to operate with power supplied by the cigarette lighters in automobiles and adaptors that allow the devices be charged or operate from power supplied household or similar wall receptacles. The batteries utilized in these devices generally have an “active” charge that allows the device to operate for only a few hours without requiring recharge or change of batteries. A method for extending the time these devices can operate without requiring recharging or changing of batteries would add to the enjoyment and convenience of the users.

In particular reference to cellular telephones, many power sources are comprised of lead acid batteries, which tend to consume as much as twice the energy while in the “roaming” mode than when operated in a non roaming mode. Likewise, lead acid batteries can damage or shorten the life of some cellular telephones.

### SUMMARY OF THE INVENTION

Therefore, it is an object of the present invention, which consist of two components, to create a portable power source, that can be utilized as supplemental or primary electric power, for operating portable personal electronic devices that can increase the enjoyment and convenience of such devices by extending the time such devices are utilized without requiring recharge or replacement of batteries. This object of the present invention can be achieved with a portable power source with “high storage” capability that can be easily carried on or about the person of someone utilizing a personal, portable electronic device.

Another object of the present invention is to create a portable electric power source that is rechargeable by means of a household or similar wall outlet, that is rechargeable by means of utilizing a cigarette lighting device included in the design and construction of automobiles, that is rechargeable by means of a solar powered charging device, that is rechargeable by a hand cranked charging device of by any other device capable of recharging the present invention. This object of the present invention can is achieved by including in the design of the present invention a charging port that will connect to a charging device, whose purpose is to recharge the present invention, with such charging device to derive power from a wall outlet. The charging port referenced herein will also have the capability of recharging the present invention from a charging device that will derive power from the electrical system of an automobile through the cigarette lighting device.

It is a further object of the present invention to be lightweight and convenient for anyone utilizing the present invention to operate on or about their person. This object can be achieved by designing the present invention in a small, lightweight configuration capable of being carried inside a purse or other handbag, attached to a belt or waist band of trousers or a skirt or inside an apparatus especially designed for transporting the present invention.

It is yet another object of the present invention to be easily transported, including the use of various devices whose purpose is to carry personal items. This objective can be achieved by incorporating the present invention into an apparatus that contains a pouch sufficient in size to securely maintain the present invention accompanied by various accessories with a second pouch sufficient in size to securely maintain a cellular telephone, personal compact disc player or similar device.

The present invention can also be configured in such a manner as to insulate the internal components as to protect them from water damage should the present invention become exposed to or submersed in water or some other liquid. Likewise, the present invention can be constructed of materials capable of withstanding the effects of acids or other corrosive substances.

### BRIEF DESCRIPTION OF THE DRAWINGS

In order that the manner in which the above recited and other advantages and features of the present invention are obtained, a more particular description of the invention summarized above is rendered by reference to the appended drawings. Understanding that these drawings represent only a selected embodiment of the present invention and are not therefore to be considered limiting of its scope, the present invention will be described and explained with additional specificity and detailed through the use of the accompanying drawings in which:

FIG. 1 is an isometric view of one embodiment of one component of the present invention illustrating the energy transfer receptacle 1, the power indicator 2 and the charger receptacle 3 for this component of the present invention FIG. 1.

FIG. 2 is an isometric view of one embodiment of the component of the present invention illustrating the opening in which the electric power storage component FIG. 1 is inserted into the main pouch 4, a cover flap 5 with a secondary flap 6, the pouch in which a cellular telephone or other personal electric device can be stored 7, a portion of the strap 8 that allows the carrying of the device and the opening for the insertion of the recharging device 9.

FIG. 3 is an isometric view of one embodiment of the present invention illustrating the present invention in its consolidated configuration with the secondary flap 6 in the closed position. FIG. 4 is an isometric view of one embodiment of the present invention illustrating the present invention in its consolidated configuration with the secondary flap 6 on the open position, exposing the energy transfer receptacle 3 and the power indicator 2.

### DETAILED DESCRIPTION OF A PREFERRED EMBODIMENT OF THE PRESENT INVENTION

Wherefore, there are many persons who have substantial knowledge of the subject matter of the present invention, and understanding that this represents only one embodiment of the present invention, it is understood that there may be other embodiments of the present invention employing the same or very similar principles, designs, components and configurations of components, to accomplish the same and other purposes or functions. Therefore, it is understood that the particular embodiment of the present invention as related and described herein is not to be deemed limiting or all encompassing as to the potential embodiments, uses, scope, designs, decorations or outcomes of the present invention. It is also understood that the locations of certain components that comprise the present invention as embodied herein may be otherwise situated on or about the present invention. Likewise, it is understood that the embodiment of the present invention contained herein illustrates the present invention as a device worn about the waist of its user. It is also within the scope of the present invention that the present invention is capable of storage and transport in a shoulder mounted device, concealed and contained within a purse or hand bag or carried by hand.

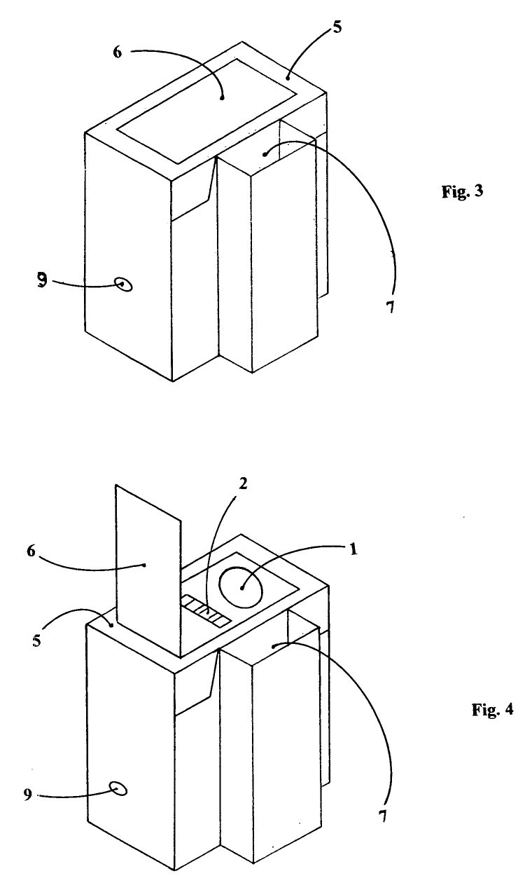

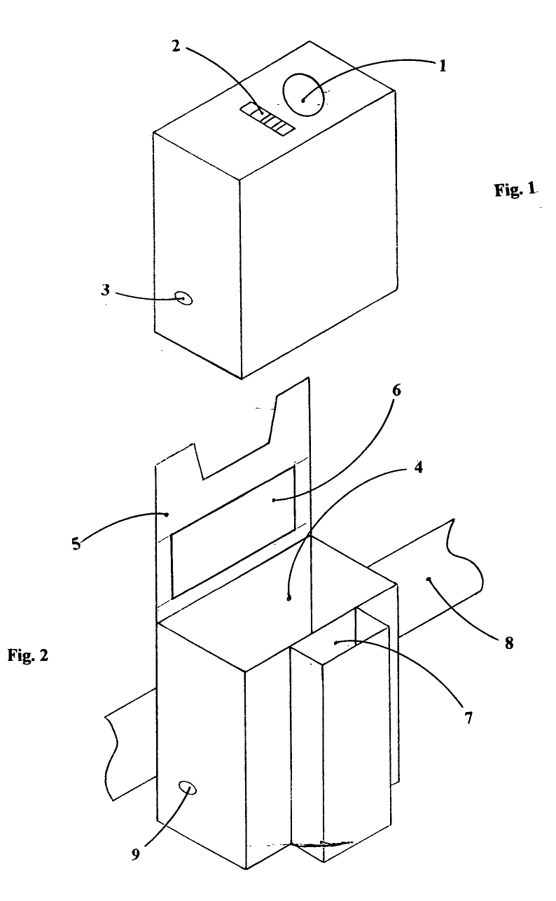

Reference is now made to the figures wherein like parts are referred to by like numerals. The present invention relates to a portable power source FIG. 1, that is lightweight, easy to transport and that provides additional electric power for portable, personal electronic devices. The present invention FIG. I is a portable power source that is rechargeable. The present invention may be charged or recharged by means of inserting the male end of a charging device (not illustrated) into the charger receptacle 3 of the present invention or through the energy transfer receptacle 1 of the present invention FIG. 1. The charging device (not illustrated) may receive its power from a wall outlet (or similar device) or from the cigarette lighting device in an automobile. As the present invention FIG. 1 is charging, the power indicator 2 will indicate battery strength. When utilizing the present invention FIG. 1, the male end of the adapter for the electronic device requiring power (not shown) is inserted into the energy receptacle 1 of the present invention, through which electronic energy will be transferred to the device. When being transported on the person of its user, it may be placed inside the main pouch 4 of the carrying case FIG. 2, which attaches to a device 6 that allows the carrying of the device about the person of the user. Accessories, such as an adapter (not shown) can also fit inside the main pouch 4, or the main pouch 4 can be divided into separate compartments for the purpose of storing accessories for the present invention. A cellular telephone or similar personal electronic device can be securely placed in the small pouch 7. The electric power storage device FIG. 1 is secured inside the carrying case FIG. 2 by means of the cover flap 5. When the cover flap 5 is closed, the adapter receptacle and the power indicator are accessible by means of the secondary flap 6.The present invention can be secured to the person of the user utilizing the waist strap 8. The small pouch 7 can be constructed of elastic or an elastic like material that will allow the same to accommodate a variety of personal electronic devices.

### FIELD OF THE INVENTION

In general, the field of the present invention relates to extending the use and enjoyment of personal electronic devices by increasing the amount of time such devices can be utilized without requiring recharging.

### BACKGROUND OF THE INVENTION

There are many personal electronic devices that the users carry on their persons, including but not limited to cellular telephones, portable compact disc players, mp3 players, portable digital video disc players, portable search lights and the like. All of these devices use batteries as their primary power source and have adaptors that allow them to operate with power supplied by the cigarette lighters in automobiles and adaptors that allow the devices be charged or operate from power supplied household or similar wall receptacles. The batteries utilized in these devices generally have an “active” charge that allows the device to operate for only a few hours without requiring recharge or change of batteries. A method for extending the time these devices can operate without requiring recharging or changing of batteries would add to the enjoyment and convenience of the users.

In particular reference to cellular telephones, many power sources are comprised of lead acid batteries, which tend to consume as much as twice the energy while in the “roaming” mode than when operated in a non roaming mode. Likewise, lead acid batteries can damage or shorten the life of some cellular telephones.

### SUMMARY OF THE INVENTION

Therefore, it is an object of the present invention, which consist of two components, to create a portable power source, that can be utilized as supplemental or primary electric power, for operating portable personal electronic devices that can increase the enjoyment and convenience of such devices by extending the time such devices are utilized without requiring recharge or replacement of batteries. This object of the present invention can be achieved with a portable power source with “high storage” capability that can be easily carried on or about the person of someone utilizing a personal, portable electronic device.

Another object of the present invention is to create a portable electric power source that is rechargeable by means of a household or similar wall outlet, that is rechargeable by means of utilizing a cigarette lighting device included in the design and construction of automobiles, that is rechargeable by means of a solar powered charging device, that is rechargeable by a hand cranked charging device of by any other device capable of recharging the present invention. This object of the present invention can is achieved by including in the design of the present invention a charging port that will connect to a charging device, whose purpose is to recharge the present invention, with such charging device to derive power from a wall outlet. The charging port referenced herein will also have the capability of recharging the present invention from a charging device that will derive power from the electrical system of an automobile through the cigarette lighting device.

It is a further object of the present invention to be lightweight and convenient for anyone utilizing the present invention to operate on or about their person. This object can be achieved by designing the present invention in a small, lightweight configuration capable of being carried inside a purse or other handbag, attached to a belt or waist band of trousers or a skirt or inside an apparatus especially designed for transporting the present invention.

It is yet another object of the present invention to be easily transported, including the use of various devices whose purpose is to carry personal items. This objective can be achieved by incorporating the present invention into an apparatus that contains a pouch sufficient in size to securely maintain the present invention accompanied by various accessories with a second pouch sufficient in size to securely maintain a cellular telephone, personal compact disc player or similar device.

The present invention can also be configured in such a manner as to insulate the internal components as to protect them from water damage should the present invention become exposed to or submersed in water or some other liquid. Likewise, the present invention can be constructed of materials capable of withstanding the effects of acids or other corrosive substances.

### BRIEF DESCRIPTION OF THE DRAWINGS

In order that the manner in which the above recited and other advantages and features of the present invention are obtained, a more particular description of the invention summarized above is rendered by reference to the appended drawings. Understanding that these drawings represent only a selected embodiment of the present invention and are not therefore to be considered limiting of its scope, the present invention will be described and explained with additional specificity and detailed through the use of the accompanying drawings in which:

FIG. 1 is an isometric view of one embodiment of one component of the present invention illustrating the adapter receptacle 1, the power indicator 2 and the energy transfer receptacle 3 for this component of the present invention FIG. 1.

FIG. 2 is an isometric view of one embodiment of the component of the present invention illustrating the opening in which the electric power storage component FIG. 1 is inserted into the main pouch 4, a cover flap 5 with a secondary flap 6, the pouch in which a cellular telephone or other personal electric device can be stored 7, a portion of the strap 8 that allows the carrying of the device and the opening for the insertion of the recharging device 9.

FIG. 3 is an isometric view of one embodiment of the present invention illustrating the present invention in its consolidated configuration with the secondary flap 6 in the closed position. FIG. 4 is an isometric view of one embodiment of the present invention illustrating the present invention in its consolidated configuration with the secondary flap 6 on the open position, exposing the energy transfer receptacle 3 and the power indicator 2.

### DETAILED DESCRIPTION OF A PREFERRED EMBODIMENT OF THE PRESENT INVENTION

Wherefore, there are many persons who have substantial knowledge of the subject matter of the present invention, and understanding that this represents only one embodiment of the present invention, it is understood that there may be other embodiments of the present invention employing the same or very similar principles, designs, components and configurations of components, to accomplish the same and other purposes or functions. Therefore, it is understood that the particular embodiment of the present invention as related and described herein is not to be deemed limiting or all encompassing as to the potential embodiments, uses, scope, designs, decorations or outcomes of the present invention. It is also understood that the locations of certain components that comprise the present invention as embodied herein may be otherwise situated on or about the present invention. Likewise, it is understood that the embodiment of the present invention contained herein illustrates the present invention as a device worn about the waist of its user. It is also within the scope of the present invention that the present invention is capable of storage and transport in a shoulder mounted device, concealed and contained within a purse or hand bag or carried by hand.

Reference is now made to the figures wherein like parts are referred to by like numerals. The present invention relates to a portable power source FIG. 1, that is lightweight, easy to transport and that provides additional electric power for portable, personal electronic devices. The present invention FIG. 1 is a portable power source that is rechargeable. The present invention may be charged or recharged by means of inserting the male end of a charging device (not illustrated) into the female receptacle 3 of the present invention or through the female receptacle 1 of the present invention FIG. 1. The charging device (not illustrated) may receive its power from a wall outlet (or similar device) or from the cigarette lighting device in an automobile. As the present invention FIG. 1 is charging, the power indicator 2 will indicate battery strength. When utilizing the present invention FIG. 1, the male end of the adapter for the electronic device requiring power (not shown) is inserted into the female receptacle 1 of the present invention, through which electronic energy will be transferred to the device. When being transported on the person of its user, it may be placed inside the main pouch 4 of the crying case FIG. 2, which attaches to a device 6 that allows the carrying of the device about the person of the user. Accessories, such as an adapter ( not shown ) can also fit inside the main pouch 4, or the main pouch 4 can be divided into separate compartments for the purpose of storing accessories for the present invention. A cellular telephone or similar personal electronic device can be securely placed in the small pouch 7. The electric power storage device FIG. 1 is secured inside the carrying case FIG. 2 by means of the cover flap 5. When the cover flap 5 is closed, the adapter receptacle and the power indicator are accessible by means of the secondary flap 6.The present invention can be sectored to the person of the user utilizing the waist strap 8.

1. A portable auxiliary or primary electric power supply for personal electronic devices with a gross weight of less than 4 pounds.

2. A portable auxiliary or primary electric power supply for personal electronic devices with the capacity of operating a cellular or digital telephone for periods exceeding 12 hours without requiring recharge; and

3. The incorporation of a storage component for a battery and a storage component for an electronic device included in a device.
